(19) United States
(12) Patent Application Publication
(10) Pub. No.: US 2012/0242448 A1
(43) Pub. Date: Sep. 27, 2012

(54) Fusible Cut-Out Link And Overcurrent Protection Device

(76) Inventors: Markus Faltermeier, Regensburg (DE); Thomas Lohr, Ihrlerstein (DE)

(21) Appl. No.: 13/419,816

(22) Filed: Mar. 14, 2012

(30) Foreign Application Priority Data
Mar. 22, 2011 (DE) 102011005883.4

(51) Int. Cl. H01H 85/02

(52) U.S. Cl. 337/186

(57) ABSTRACT

A fusible cut-out link, e.g., for semiconductor fuses, may have a ceramic body filled with compacted sand, wherein a supplementary body is introduced into the compacted sand. Said supplementary body may be embodied in such a way that an increase in internal pressure in the ceramic body due to thermal expansion of the compacted sand causes the supplemental body to release an additional volume into which the compacted sand is allowed to expand. In this manner, it may be possible to avoid or limit damage to the ceramic body due to stress fractures caused by the different rates of thermal expansion of the compacted sand and of the ceramic body as a result of an increase in temperature and the increase in internal pressure in the ceramic body associated therewith. The robustness of the fusible cut-out link may be significantly improved as a result.

### CROSS-REFERENCE TO RELATED APPLICATIONS

This application claims priority to DE Patent Application No. 10 2011 005 883.4 filed Mar. 22, 2011. The contents of which is incorporated herein by reference in its entirety.

### TECHNICAL FIELD

This disclosure relates to a fusible cut-out link—e.g., for semiconductor fuses—which has a ceramic body filled with compacted sand. The disclosure further relates to an overcurrent protection device having a fusible cut-out link of said type.

### BACKGROUND

A fusible cut-out is an overcurrent protection device which interrupts the electric circuit as a result of the melting of one or more fusible conductors when the intensity of the current exceeds a specific value over a specific period of time. The cut-out consists of an insulating body having two electrical terminals which are connected to each other in the interior of the insulating body by means of a fusible conductor. The fusible conductor is heated by the current flowing through it and melts if the relevant rated current of the fuse is significantly exceeded for a specific period of time. Ceramic is mostly used as the material for the insulating body on account of its good insulating effect.

In a sand-filled fusible cut-out link, the fusible conductor is surrounded by compacted quartz sand. The housing of the fuse link is formed by a ceramic body in which the compacted sand, the electrical terminals and the fusible conductor are accommodated or retained. In this arrangement the quartz sand acts as an arc quenching means: if the rated current of the fusible cut-out is significantly exceeded—due to a short-circuit for example—this leads to a response by the fusible cut-out in the course of which the fusible conductor initially melts and subsequently vaporizes due to the high temperature development. This results in the formation of an electrically conductive plasma via which the flow of current between the electrical terminals is initially maintained, producing an electric arc. As the metal vapor of the vaporized fusible conductor is precipitated on the surface of the quartz sand grains, the arc is cooled down again. Subsequently the resistance in the interior of the fuse link increases to such an extent that the arc is finally extinguished. The circuit that is to be protected by means of the fusible cut-out is interrupted as a result.

In sand-filled fusible cut-out links having a large volume of compacted sand, stresses are produced in the ceramic body due to the different coefficients of thermal expansion of the quartz sand on the one hand and of the ceramic body on the other, which may ultimately lead to the rupturing of the ceramic body. Commercially available fusible cut-out links counteract this problem by employing specialized, high-quality ceramics which are characterized for example by a higher aluminum oxide content. In addition to higher strength, ceramics of said type also have a greater coefficient of thermal expansion than comparable ceramics having a lower aluminum oxide content. Both properties—the higher strength and the higher coefficient of thermal expansion—mitigate the problem of damage to the ceramic body. Owing to their special high-quality properties, however, the ceramic materials that are considered suitable for this purpose are relatively expensive.

Furthermore, in order to reduce the stresses in the ceramic body due to the thermal expansion of the compacted sand, fusible cut-out links are available in which a damping element is arranged along the inner circumference of the ceramic body between the ceramic body and the compacted sand. However, this arrangement has the disadvantage that the heat dissipation of the fusible cut-out link and consequently the tripping and disconnecting behavior of the fusible cut-out link are rendered significantly worse.

### SUMMARY

In one embodiment, a fusible cut-out link, in particular for semiconductor fuses, has a ceramic body filled with compacted sand, wherein there is introduced into the compacted sand a supplementary body which is embodied in such a way that if there is an increase in internal pressure in the ceramic body due to thermal expansion of the compacted sand, an additional volume in the ceramic body is released by the supplementary body in order to allow the compacted sand to expand.

In a further embodiment, the supplementary body is embodied as a bursting body which ruptures when a predefined internal pressure is reached in the ceramic body, thereby releasing the additional volume. In a further embodiment, the bursting body is filled with an air or gas mixture. In a further embodiment, the bursting body is filled with uncompacted sand. In a further embodiment, the bursting body is filled with an elastic material. In a further embodiment, the supplementary body is embodied as a compressible solid body. In a further embodiment, the ceramic body can be produced by means of extrusion.

In another embodiment, an overcurrent protection device includes at least one fusible cut-out link having a ceramic body filled with compacted sand, wherein there is introduced into the compacted sand a supplementary body which is embodied in such a way that if there is an increase in internal pressure in the ceramic body due to thermal expansion of the compacted sand, an additional volume in the ceramic body is released by the supplementary body in order to allow the compacted sand to expand.

### BRIEF DESCRIPTION OF THE DRAWINGS

Example embodiments will be explained in more detail below with reference to figures, in which:

FIG. 1 shows a perspective view of an example fusible cut-out link, according to an example embodiment, and

FIG. 2 shows a side view of the example fusible cut-out link of FIG. 1.

### DETAILED DESCRIPTION

Some embodiments provide a fusible cut-out link and an overcurrent protection device having such a fusible cut-out link which may provide an improved robustness while at the same time being easier and more cost-effective to produce.

In some embodiments, a fusible cut-out link, e.g., for semiconductor fuses, has a ceramic body filled with compacted sand, wherein a supplementary body is incorporated into the compacted sand. Said supplementary body is embodied in such a way that if there is an increase in internal pressure in the ceramic body due to thermal expansion of the compacted sand, an additional volume in the ceramic body is released by the supplementary body in order to allow the compacted sand to expand.

In some embodiments, the ceramic body and the compacted sand have different coefficients of thermal expansion, i.e., in the event of an increase in temperature the compacted sand expands to a greater extent than the ceramic body surrounding the compacted sand, which leads as the temperature increases to an increase in the internal pressure in the ceramic body and consequently to stresses in the ceramic body. Through the use of a supplementary body with the aid of which an additional volume is provided in the ceramic body if there is an increase in the internal pressure, which additional volume is available to allow further expansion of the compacted sand, the internal pressure arising in the ceramic body can be limited to a tolerable value. In this way the possibility of damage to the ceramic body due to stress fractures caused by the different rates of thermal expansion of the compacted sand and of the ceramic body may be avoided or reduced. The robustness of the fusible cut-out link may be significantly improved as a result.

Furthermore, in some embodiments, a ceramic having a lower aluminum oxide content can be used for producing the ceramic body. A ceramic of said type may be cheaper to produce and also easier to process, which as a result may significantly reduce he production costs of the fusible cut-out link. In designs intended for use in standard applications this allows a less complex ceramic to be used while maintaining the same performance; specialized designs for problematic application conditions for which even high-quality ceramics are not adequate can be realized by incorporating a supplementary body in the compacted sand.

In an advantageous development of the fusible cut-out link the supplementary body may be embodied as a bursting body which ruptures when a predefined internal pressure in the ceramic body is reached, as a result of which the additional volume is released. The bursting body introduced into the sand typically has a thin-walled housing which gives way irreversibly at a predefined internal pressure prevailing in the interior of the ceramic body and disintegrates, as a result of which at least part of the volume surrounded by the thin-walled housing is released and is available to allow further expansion of the compacted sand. With this solution it is also possible to incorporate a plurality of bursting bodies into the compacted sand, these being dimensioned for example for different internal pressures and rupturing one by one if there is a surge in the internal pressure, with the result that the additional volume for allowing further expansion of the compacted sand may be released in a cascaded manner, i.e., in a plurality of portions.

In another advantageous development of the fusible cut-out link the bursting body may be filled with an air or gas mixture. Filling the bursting body with air may provide a fusible cut-out link that is simple to implement and can be achieved at low cost. A gas mixture—including for example inert or sluggishly reacting, gases such as nitrogen or noble gases—can also be used instead of air.

In a further advantageous development of the fusible cut-out link the bursting body may be filled with uncompacted sand. In this way the additional volume to be provided due to rupturing of the bursting body can be limited to a low value without this at the same time adversely affecting the tripping precision of the fusible cut-out link. In order to maintain this precision, i.e., in order to determine the threshold value of the internal pressure as of which the bursting body is intended to rupture as accurately as possible, a specific manufacturing precision of the bursting body in terms of its geometry and its wall thickness may be required; this in turn may necessitate that the bursting body be of a minimum size, which is difficult to realize in the case of only a small additional volume. On the other hand, filling the bursting body with uncompacted sand permits only a small additional volume to be made available for further expansion of the compacted sand, even with the above-described, geometrically imposed minimum size of the bursting body, wherein the rupturing of the bursting body as a function of the internal pressure can be predetermined with a relatively good degree of precision.

In another advantageous development of the fusible cut-out link the bursting body may be filled with an elastic material. Like the filling with uncompacted sand, filling the bursting body with an elastic material constitutes a suitable means of making only a limited additional volume available for further expansion of the compacted sand. At the same time filling the volume reservoir with an elastic material may have the further advantage that no cavities will ensue in the compacted sand even after the bursting body has ruptured. Instead, the further expansion of the compacted sand may be realized through a compression of the elastic body while the internal pressure remains virtually the same.

In a further advantageous development of the fusible cut-out link the supplementary body may be embodied as a compressible solid body. In this case, too, the further expansion of the compacted sand is realized through a compression of the elastic body while the internal pressure remains virtually the same or increases only marginally. In this case, however, this principle comes into effect not just as of the threshold value for the internal pressure at which the supplementary body ruptures, but right from the beginning.

In a further advantageous development of the fusible cut-out link the ceramic body can be produced by extrusion. An extrusion method may provide a simple and extremely cost-effective means of manufacturing the ceramic body which may be suitable, e.g., for processing simple ceramic materials. High-quality ceramic materials, e.g., materials of such type having a high aluminum oxide content, may only be suitable to a degree for processing with the aid of an extrusion method or may even be totally unsuitable.

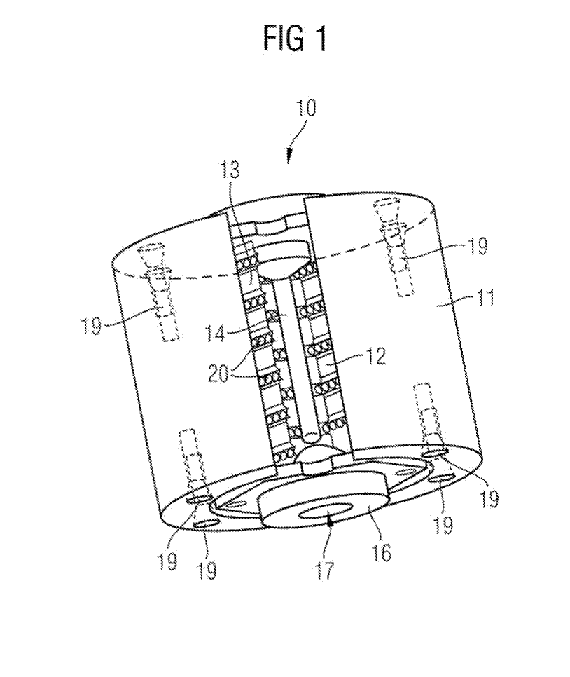

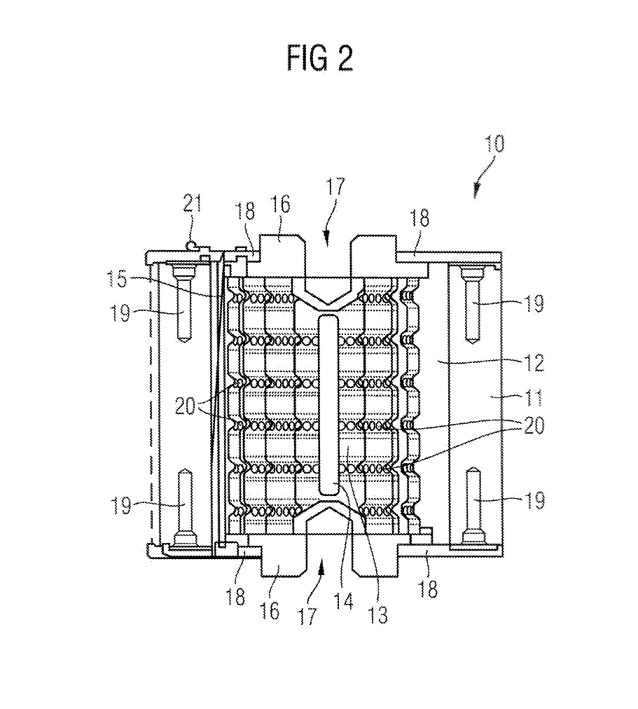

The overcurrent protection device according to certain embodiments may have at least one fusible cut-out link as described herein. FIG. 1 shows a perspective view of an example fusible cut-out link 10 according to certain embodiments. FIG. 2 shows a side view of the example fusible cut-out link 10 of FIG. 1. The fusible cut-out link 10 has a ceramic body 11 which in the present case is embodied in the form of a hollow cylinder, with the interior of the ceramic body 11 essentially serving as a holding space 12 for accommodating compacted sand (not shown). Arranged in each case at each of the two openings of the hollow cylindrical ceramic body 11 is a contact element 16 via which the fusible cut-out link 10 can be electrically contacted. Toward that end the contact element 16 has a receptacle 17 in the form of a blind hole via which an electrical connecting element can be securely connected—by way of a screwed connection for example—to the fusible cut-out link 10. The respective contact element 16 may be centered relative to the ceramic body 11 with the aid in each case of a cover plate 18 which can be secured to the ceramic body 11 by way of a plurality of boreholes 19 embodied in the ceramic body. The openings of the hollow cylindrical ceramic body 11 may also be sealed in a pressure-tight manner by means of the two cover plates 18. As an alternative to a hollow cylinder, other hollow shapes, for example hollow parallelepipeds or hollow prisms, can also be used for forming the ceramic body 11.

Also arranged in the holding space 12 in addition are a plurality of fusible conductors 13 which connect the two contact elements 16 to each other in an electrically conducting manner, as well as what is termed an indicator wire 15 which likewise connects the two contact elements 16 in an electrically conducting manner. The indicator wire 15 may be brought out at one end of the fusible cut-out link 10 and may securely attach an indicating element 21—also simply called an indicator—that is held under mechanical tension by means of a spring. Each of the fusible conductors 13 may include a plurality of narrow points 20 over its length, such that the tripping characteristics of the fusible cut-out link 10 can be influenced in a targeted manner by way of the configuration and embodiment of said narrow points 20. In this example embodiment, a supplementary body in the form of a bursting body 14 is also disposed in the holding space 12. The remaining holding space 12 may be filled with compacted sand, for example quartz sand, by means of which the bursting body 14 may be held in its position. For clarity of illustration reasons, however, the compacted sand is not shown in the figures. The bursting body 14 occupies a defined volume in the compacted sand and ruptures when the internal pressure in the interior of the ceramic body 11 exceeds a predefined threshold value—for example due to thermal expansion of the compacted sand during a tripping of the fusible cut-out link 10.

With currents that are smaller than the rated current of the fusible cut-out link 10, only so much thermal power loss is converted in the fusible conductors 13 as can be dissipated in the form of heat to the outside quickly by way of the sand, the ceramic body 11 and the contact elements 16. In this case the temperature of the fusible conductors 13 does not rise above their melting point. On the other hand, if a current flows which lies in the overload range of the fusible cut-out link 10, the temperature in the interior of the fusible cut-out link 10 will continue to climb steadily until the melting point of the fusible conductors 13 is exceeded and the fusible conductors melt through at their narrow points 20. At high residual currents, caused for example by a short-circuit, so much energy is converted in the fusible conductors 13 that they are heated practically over their whole length and as a result melt simultaneously at the narrow points 8. Because liquid metal still exhibits good electrically conducting properties, the current continues to flow by way of the molten mass until the latter vaporizes and an electric arc is produced. The extremely high temperatures occurring during this process cause the surrounding quartz sand to fuse, leading to a chemical reaction between the molten metal and the quartz sand. The reaction product resulting therefrom is a good insulator which finally interrupts the current flow. Almost simultaneously with the melting of the fusible conductor 13 the indicator wire 15 also burns through. As a result the indicating element 21 is no longer held fast and moves into a new position on account of the spring force being applied. The tripping of the fusible cut-out link 10 is indicated in this way.

A great deal of heat may be generated as a result of a plurality of electric arcs being produced during the tripping of the fusible cut-out link 10, leading to an increase in the temperature of the compacted sand and consequently—due to thermal expansion—to an expansion of the compacted sand. Since the coefficient of thermal expansion of the compacted sand is greater than the coefficient of thermal expansion of the ceramic body 11 surrounding the compacted sand, this causes an increase in the internal pressure in the ceramic body 11. In order to avoid damage to the ceramic body 11, such as stress fractures for example, the bursting body 14 ruptures as of a defined threshold value of the internal pressure. As a result thereof the volume enclosed by the bursting body—which volume may be filled for example with an air or gas mixture, with uncompacted sand or with an elastic material—is released. Because the compacted sand can now expand into said volume, the internal pressure decreases once again to a value below the threshold value. Using an appropriate choice of the threshold value, damage to the ceramic body can thus be avoided or limited.

In an alternative embodiment, the supplementary body is a compressible solid body (e.g., an elastic body), rather than a bursting body. In this case, the further expansion of the compacted sand can be realized through a compression of the compressible body while the internal pressure remains virtually the same or increases only marginally. Unlike with the bursting body, however, compression of the compressible solid body may occur upon the beginning of a rise in internal pressure, not just at a defined threshold value.

### LIST OF NUMBERED ELEMENTS IN THE DRAWINGS

10 Fusible cut-out link
11 Ceramic body
12 Holding space
13 Fusible conductor
14 Supplementary body/bursting body
15 Indicator wire
16 Contact element
17 Receptacle
18 Cover plate
19 Borehole
20 Narrow points
21 Indicating element

What is claimed is:

1. A fusible cut-out link for a semiconductor fuse, comprising:
a ceramic body having a holding space filled with compacted sand, and
a supplemental body disposed in the holding space, the supplemental body being configured such that an increase in pressure in the ceramic body due to thermal expansion of the compacted sand causes the supplementary body to release an additional volume in the ceramic body into which can expand.

2. The fusible cut-out link of claim 1, wherein the supplementary body comprises a bursting body that ruptures when a predefined pressure is reached in the ceramic body, thereby releasing the additional volume.

3. The fusible cut-out link of claim 2, wherein the bursting body is filled with an air or gas mixture.

4. The fusible cut-out link of claim 2, wherein the bursting body is filled with uncompacted sand.

5. The fusible cut-out link of claim 2, wherein the bursting body is filled with an elastic material.

6. The fusible cut-out link of claim 1, wherein the supplementary body comprises a compressible solid body.

7. The fusible cut-out link of claim 1, wherein the ceramic body comprises an extruded structure.

8. The fusible cut-out link of claim 1, further comprising:
a pair of contact elements, and
a plurality of fusible conductors that connect the pair contact elements to each other in an electrically conducting manner.

9. The fusible cut-out link of claim 8, wherein each contact element is centered with respect to the ceramic body

10. The fusible cut-out link of claim 8, wherein each fusible conductor includes a plurality of narrow points configured to influence a tripping characteristic of the fusible cut-out link.

11. The fusible cut-out link of claim 10, wherein the plurality of narrow points are arranged around a circumference of each fusible conductor.

12. The fusible cut-out link of claim 1, further comprising:
an indicator wire that connects the two contact elements in an electrically conducting manner, and
an indicating element connected to the indicator wire and held under mechanical tension by means of a spring.

13. An overcurrent protection device, comprising:
at least one fusible cut-out link including:
a ceramic body having a holding space filled with compacted sand, and
a supplemental body disposed in the holding space, the supplemental body being configured such that an increase in pressure in the ceramic body due to thermal expansion of the compacted sand causes the supplementary body to release an additional volume in the ceramic body into which can expand.

14. The overcurrent protection device of claim 13, wherein the supplementary body comprises a bursting body that ruptures when a predefined pressure is reached in the ceramic body, thereby releasing the additional volume.

15. The overcurrent protection device of claim 14, wherein the bursting body is filled with an air or gas mixture.

16. The overcurrent protection device of claim 14, wherein the bursting body is filled with uncompacted sand.

17. The overcurrent protection device of claim 14, wherein the bursting body is filled with an elastic material.

18. The overcurrent protection device of claim 13, wherein the supplementary body comprises a compressible solid body.

19. The overcurrent protection device of claim 13, wherein the ceramic body comprises an extruded structure.

20. The overcurrent protection device of claim 13, wherein each fusible cut-out link further comprises:
a pair of contact elements, and
a plurality of fusible conductors that connect the pair contact elements to each other in an electrically conducting manner, each fusible conductor including a plurality of narrow points configured to influence a tripping characteristic of the fusible cut-out link.
